(19) United States
(12) Patent Application Publication
(10) Pub. No.: US 2008/0157489 A1
(43) Pub. Date: Jul. 3, 2008

(54) Socket locking assembly

(76) Inventor: Jui-Chien Kao, Tali City (TW)

Correspondence Address: JACKSON WALKER, L.L.P., 112 E. PECAN, SUITE 2400, SAN ANTONIO, TX, 78205, US

(21) Appl. No.: 11/645,996

(22) Filed: Dec. 27, 2006

(51) Int. Cl. B23B 31/10

(52) U.S. Cl. 279/97

(57) ABSTRACT

A socket locking assembly includes an assembly column having a body, two extensions extending from a bottom face of the body, a positioning hole defined through the body and a retaining boss formed on a side face extending between the two extensions and a locking pin extendable into the positioning hole from a bottom of the assembly column and having a top stop, a bottom stop and a secondary positioning such that after the two extensions and the locking pin are extendable into the space of the socket and the top stop of the locking pin is extended through the positioning hole of the assembly column, abutment of the top stop with a top face of the body as well as the retaining boss and the secondary positioning boss received in the indents of the socket prevent the socket from removal.

### BACKGROUND OF THE INVENTION

1. Field of the Invention

The present invention relates to a socket locking assembly, and more particularly to a socket locking assembly adapted for sockets of different kinds.

2. Description of the Prior Art

There are two kinds of sockets available on the market, the first one is provided with a bit integrally formed on one end of the socket and the second one is without a bit formed on one end of the socket. The first socket has a blind hole defined in the other end of the socket and opposite to that of the bit. The second socket has a channel defined through the socket body.

When either socket is displayed on a shelf, different locking mechanism is required for each of the two different sockets to prevent the first socket from being stolen. That is, a first locking mechanism is required to limit removal of the sockets. The first locking mechanism includes a bracket, a locking core and a description plate having a dovetailed rail formed on a bottom face of the description plate. The assembly column is provided to extend into the blind hole of the socket body and has a dovetailed track defined in a top face thereof to correspond to and receive therein the dovetailed rail of the description plate such that after the dovetailed rail of the description plate is received in the dovetailed track of the assembly column, the assembly column is able to slide relative to the description plate. Then the bracket having an elongated hole is secured to opposite sides of the description plate with the bits of the sockets extending over the elongated hole. Due to the limitation of the elongated hole to the socket bits of the sockets, the sockets are securely attached to the description plate and removal of the entire sockets along with the description plate without authorization is not going to be easy.

The second locking mechanism for the second socket that has a through hole defined through the socket body is provided with an assembly column, a locking pin and a description plate. The description plate has a dovetailed rail formed on a bottom portion thereof and the assembly column has a dovetailed track formed on a top portion thereof to correspond to and receive therein the dovetailed rail of the description plate. The assembly column is extended into the through hole of the socket body of the second socket. Then the locking pin is extended into the through hole of the socket body in a direction opposite to that of the assembly column. The extension of the locking pin into the through hole of the socket allows a hook formed on a distal end of the locking pin to extend out of a hole in the assembly column. Thus due to the extension of the locking pin into the through hole of the socket body and the hole of the assembly column, the second socket is retained and securely attached to the description plate. Only when the hook of the locking pin is removed by such as cutting, can the second socket be removed away from the description plate.

Either locking mechanism is designed particularly to a specific socket structure and can never be switched for one another. That is, the user will have to have different locking mechanisms for these two different sockets, which increases a great deal of the cost.

To overcome the shortcomings, the present invention tends to provide an improved socket locking assembly to mitigate the aforementioned problems.

### SUMMARY OF THE INVENTION

The primary objective of the present invention is to provide a socket locking assembly to adapt to sockets of different types.

In order to accomplish the aforementioned objective, the socket locking assembly includes an assembly column and a locking pin. The assembly column has a body, two extensions extending downward from a bottom face of the disk, a retaining boss formed on a side face extending between the two extensions, a positioning hole defined through the body. The locking pin has a top stop, a bottom stop both formed on one side of the locking pin and a secondary positioning boss formed on the side of the locking pin. The locking pin is able to extend between the two extensions and through the positioning hole. The top stop is a barb and the bottom stop has a form of a wedge. That is, the bottom stop has a flat top face and an inclined bottom face.

Therefore, after the locking pin is extending through the positioning hole of the body of the assembly column, the flat top face of the bottom stop prevents the locking pin to extend further relative to the assembly column. The top stop has a flat bottom face with which the locking pin is then securely connected to the assembly column.

Further the secondary positioning boss of the locking pin is able to extend into a corresponding one of recesses defined in an inner face of a socket to secure the socket while the locking pin is securely connected to the assembly column.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the socket locking assembly of the present invention;

FIGS. 2A-2D are schematic operational views showing the assembly of the socket locking assembly and the socket;

FIG. 3 is a schematic view with partial in cross section, which shows the relative structural relationship between the socket locking assembly and the socket after combination;

FIGS. 4A and 4B are schematic operational views showing the locking effect of the socket locking assembly when the socket is forced to detach from the socket locking assembly;

FIG. 5 is a schematic cross sectional view showing the engagement of the bottom stop of the locking pin with a bottom face of the positioning hole;

FIG. 6 is a perspective view showing a description plate is employed with the socket locking assembly of the present invention;

FIG. 7 is a top plan view showing that the socket locking assembly is arranged in two opposite sides of the description plate shown in FIG. 6;

FIG. 8 is an exploded perspective view showing still a different description plate incorporating with the socket locking assembly of the present invention;

FIG. 9 an exploded perspective view showing a different embodiment of the socket locking assembly of the present invention, wherein the assembly column is integrally formed with the description plate;

FIG. 10 is a schematic view with partial in cross section, wherein the socket locking assembly of this embodiment is securely engaged with the socket to prevent the socket from being removed away from the socket locking assembly;

FIG. 11 is a perspective view showing the socket locking assembly of the present invention is incorporated with a different description plate; and

FIG. 12 is a top plan view showing that the socket locking assembly is arranged on two opposed sides of the description plate having a wrench attached to a top side face of the description plate.

### DETAILED DESCRIPTION OF THE PREFERRED EMBODIMENT

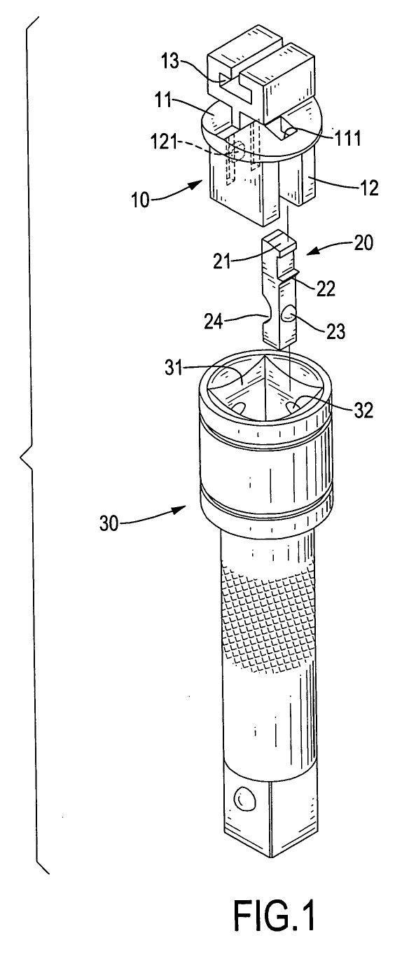

With reference to FIG. 1, it is noted that the socket locking assembly in accordance with the present invention includes an assembly column (10) and a locking pin (20), which are adapted for a socket (30) having a space (31) defined in one end of the socket (30). The socket (30) further has multiple indents (32) defined in an inner face defining the space (31).

The assembly column (10) has a body (11) with a positioning hole (111) defined through the body (11), two extensions (12) extending from a bottom face of the body (11) and a dovetailed track (13) formed on a top face of the body (11). A retaining boss (121) is formed on a side face extending between the two extensions (12).

Preferably, the two extensions (12) are separated from each other and the positioning hole (111) communicates with a space between the two extensions (12). The retaining boss (121) is preferably formed on a side face stamped from a side face extending between the two extensions (12) such that the side face as well as the retaining boss (121) is elastically formed on a side face extending between the two extensions (12).

The locking pin (20) is an elongated rod to be extended into the positioning hole (111) of the assembly column (10) and includes a top stop (21), a bottom stop (22) both formed on a side face of the locking pin (20), a secondary positioning boss (23) and an arcuate cutout (24) defined in a side face opposite to that of the secondary positioning boss (23).

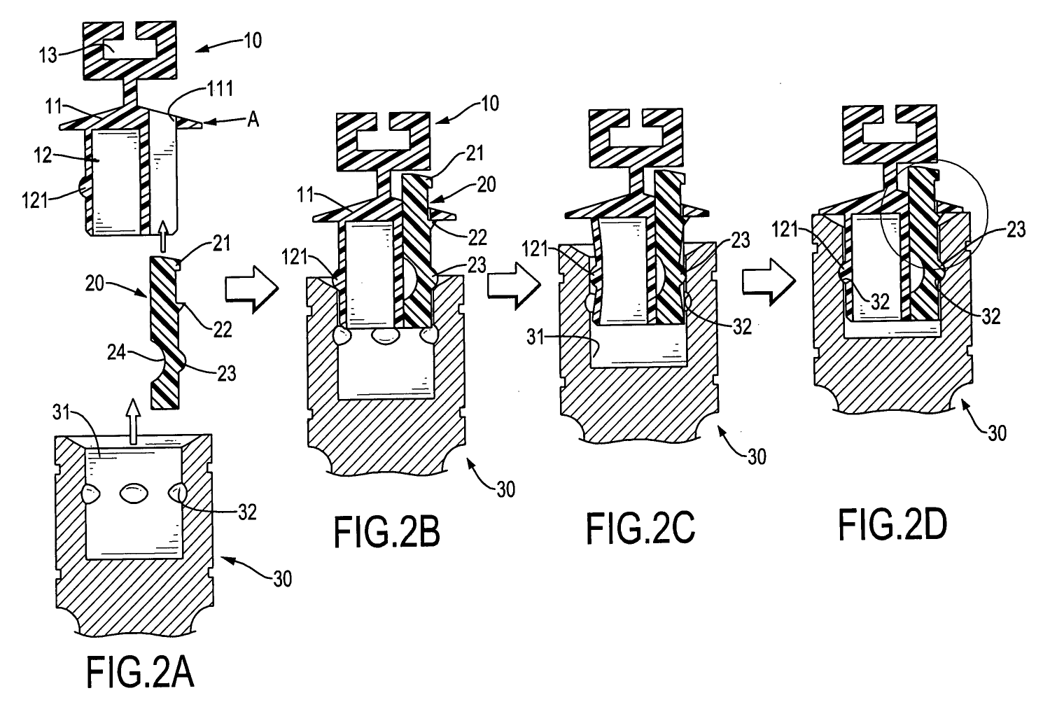

With reference to FIGS. 2A, 2B, 2C and 2D, when the socket (30) is to be incorporated with the socket locking assembly of the present invention, it is noted that the operator pushes the locking pin (20) upward first to allow the top stop (21) to extend over a top face of the positioning hole (111). Due to the engagement between the top stop (21) and the top face of the positioning hole (111), the locking pin (20) is securely connected to the assembly column (10). Then the operator pushes the socket (30) upward. It is to be noted that while the socket (30) is moving upward, both extensions (12) of the assembly column (10) as well as the locking pin (20) are received in the space (31) of the socket (30), which allow the retaining boss (121) of the assembly column (10) and the secondary positioning boss (23) of the locking pin (20) to abut an inclined side face defining the space (31). Continuous upward movement of the socket (20) forces the locking pin (20) to move in the same direction, which makes the bottom stop (22) to abut the bottom face of the body (11). If a force is continuously applied to the socket (30) to force the socket (30) to move upward, at first one of the two extensions (12) that has the retaining boss (121) formed thereon as well as the locking pin (20) is deformed due to the provision of the stamped side wall of the extension (12) and of the arcuate cutout (24) of the locking pin (20) to create a clearance to allow both the retaining boss (121) and the secondary positioning boss (23) to slide into the space (31) of the socket (30) and are received in two corresponding indents (32) of the socket (30) eventually.

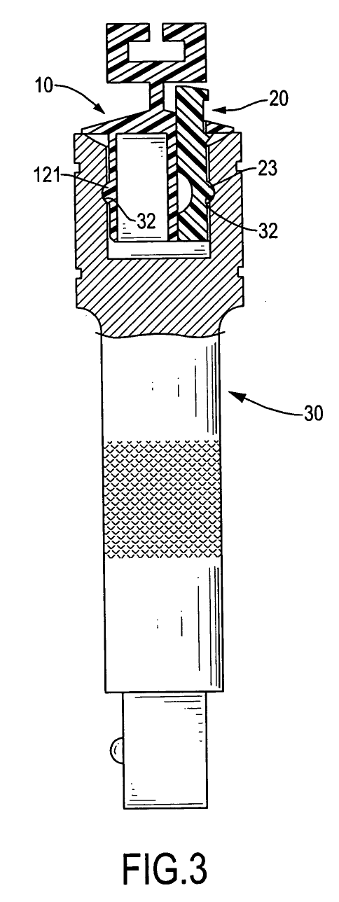

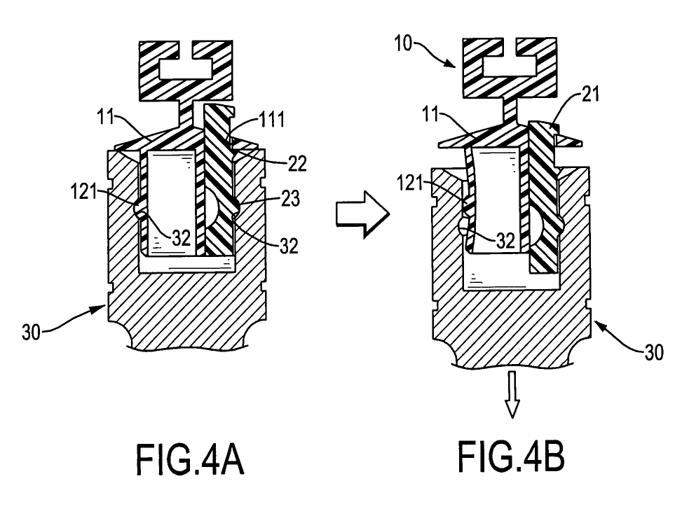

With reference to FIG. 3 and FIGS. 4A and 4B, it is noted that after the combination of the socket locking assembly of the present invention and the socket (30) is finished, because both the retaining boss (121) of the assembly column (10) and the secondary positioning boss (23) of the locking pin (20) are received in the corresponding indents (32) of the socket (30), pulling the socket (30) downward to try to force the socket (30) away from the socket locking assembly of the present invention results in even more secured engagement between the top stop (21) and the bottom face of the body (11). Further, while the socket (30) is forced to move away from the socket locking assembly of the present invention, the retaining boss (121) of the assembly column (10) may leave the corresponding indent (32) of the socket (30).

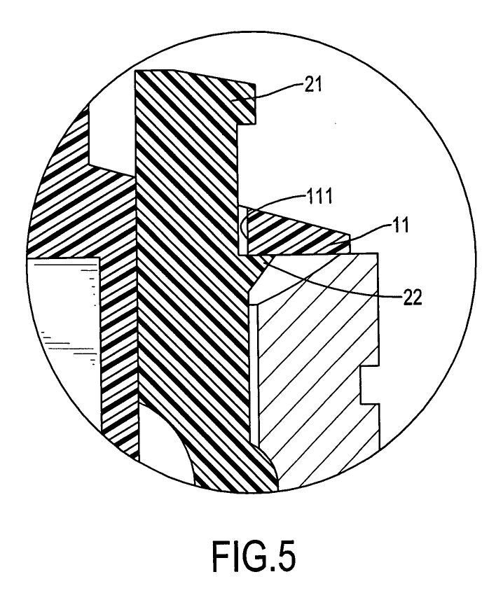

With reference to FIG. 5, it is noted that the bottom stop (22) is of a wedge that has an inclined bottom face and a flat top face to facilitate secured engagement with the bottom face of the body (11). However, when the socket (30) is to be moved by authorized personnel, the operator may cut off the top stop (21) to allow the locking pin (20) to escape from the positioning hole (111), which consequently allows the socket (30) to be removed from the assembly column (10).

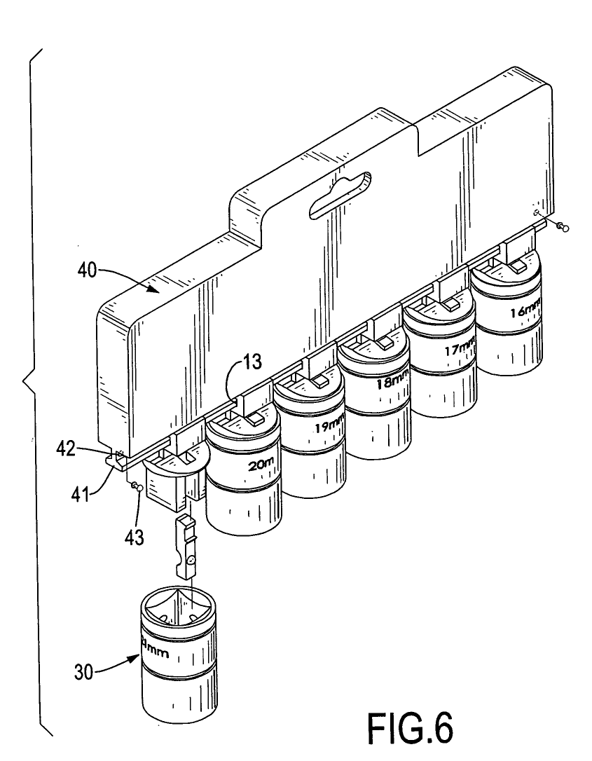

With reference to FIG. 6, it is noted that the socket locking assembly of the present invention may also include a description plate (40) which has a dovetailed rail (41) formed on a bottom face thereof, two holes (42) formed on two opposed sides of the dovetailed rail (41) and two locking bolts (43) respectively extending into the two holes (42). That is, when the dovetailed rail (41) is received in the dovetailed track (13) of the socket locking assembly of the present invention, the socket locking assembly as well as the socket (30) is able to slide on the dovetailed rail (41). Consequently, the operator is able to slide as many as socket locking assemblies as well as sockets (30) onto the dovetailed rail (41) to let the description plate (40) to hold the combination of the socket locking assembly and the socket (30). Then after plural socket locking assemblies as well as the sockets (30) are movably mounted on the dovetailed rail (41) of the description plate (40), the operator is able to extend each of the locking bolts (43) into a corresponding hole (42) to prevent the combination of the socket locking assembly and the socket (30) from detachment with the description plate (40).

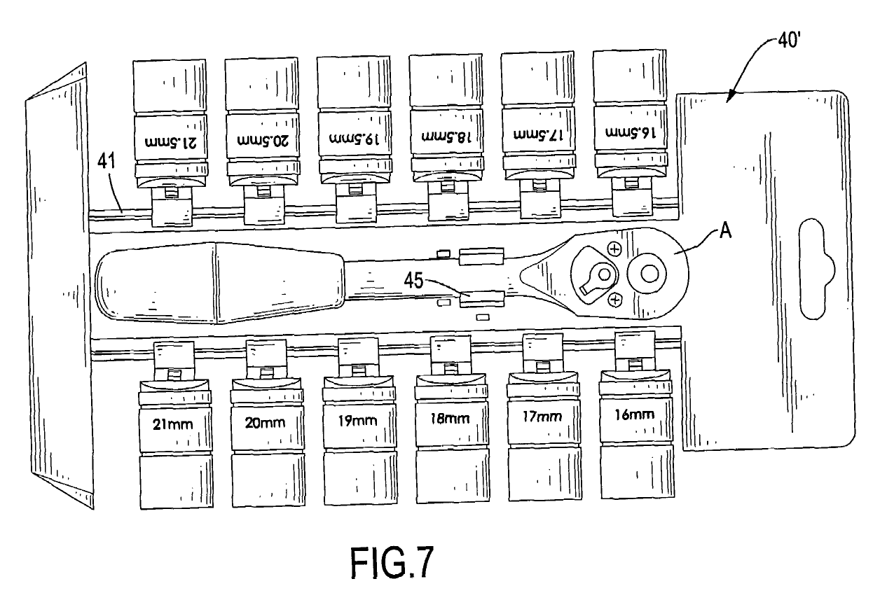

From depiction of FIG. 7, it is noted that the description plate (40) may have a pair of dovetailed rails (41) formed on two opposed sides of the description plate (40) so that the operator is able to use the two dovetailed rails (41) to attach even more combination of the socket locking assemblies and the sockets (30).

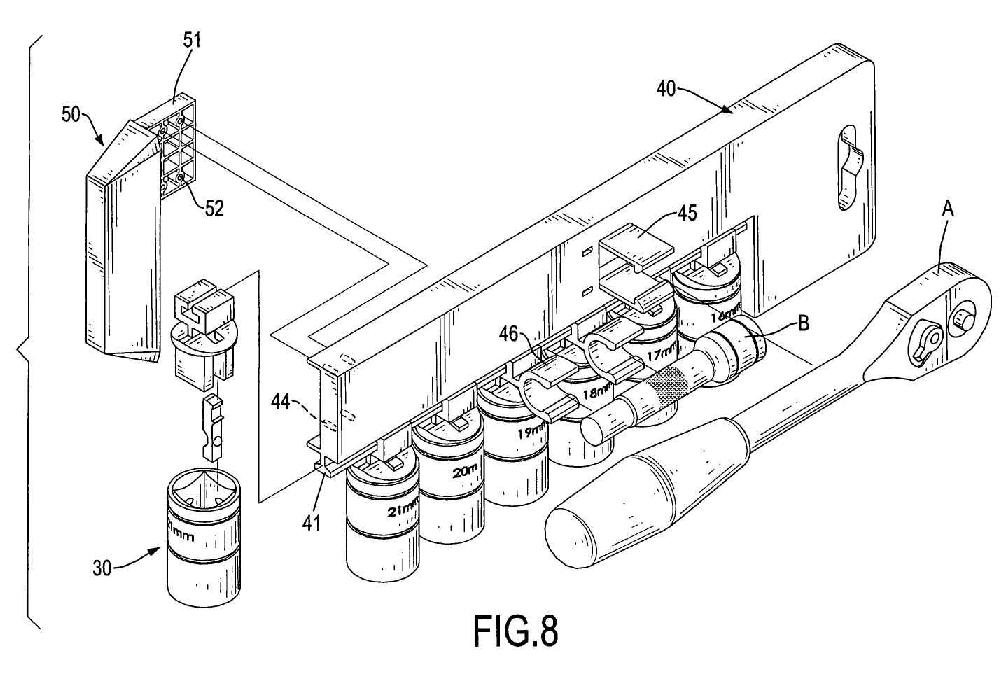

As already discussed in FIG. 6 that locking bolts and holes are used to prevent the combination of the socket locking assemblies and the sockets from detachment with the description plate (40). However, when the description plate (40) is of an L shape, a different precaution measure should be taken to prevent the combination of the socket locking assembly and the socket from detachment with the description plate (40). As shown in FIG. 8, there is provided with a plug (50) having a wing (51) integrally extending from a side face of the plug (50) and having tubes (52) formed on a side face of the wing (51). On a side face of the description plate (40), plural rods (44) are formed to correspond to the tubes (52) of the plug (50). Therefore, after the socket locking assemblies as well as the sockets (30) are slidably mounted on the dovetailed rail (41) of the description plate (40), extension of the rods (44) into the corresponding tubes (52) secures the plug (50) on a side of the description plate (40). Thus the plural socket locking assemblies as well as the sockets (30) are stopped from detachment with the description plate (40). Still furthermore, a first clamp (45) and a second clamp (46) are formed on a side face opposite to the side face having thereon the rods (44) to provide a firm grip for a wrench (A) and an extension rod (B).

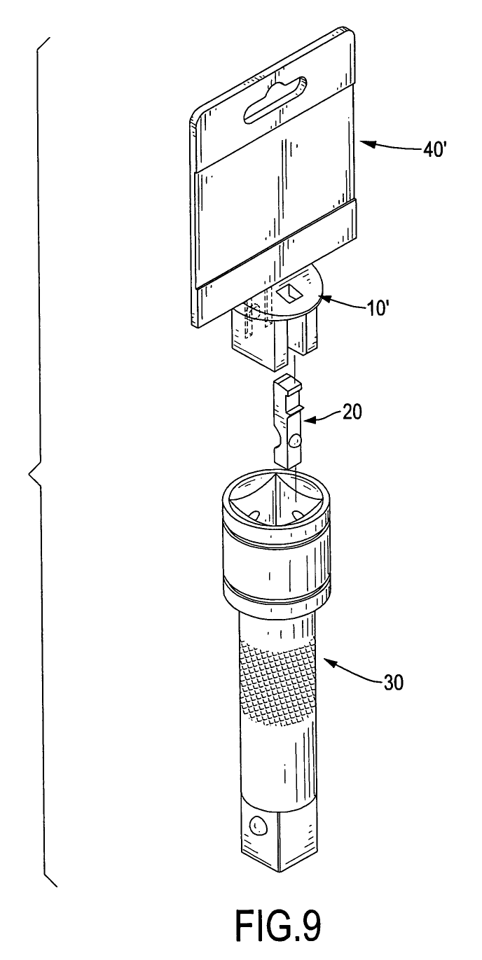

With reference to FIG. 9, the description plate (40′) is integrally formed on top of the assembly column (10′). Except for this difference, the structure of the locking pin (20) and the socket (30) is remained the same.

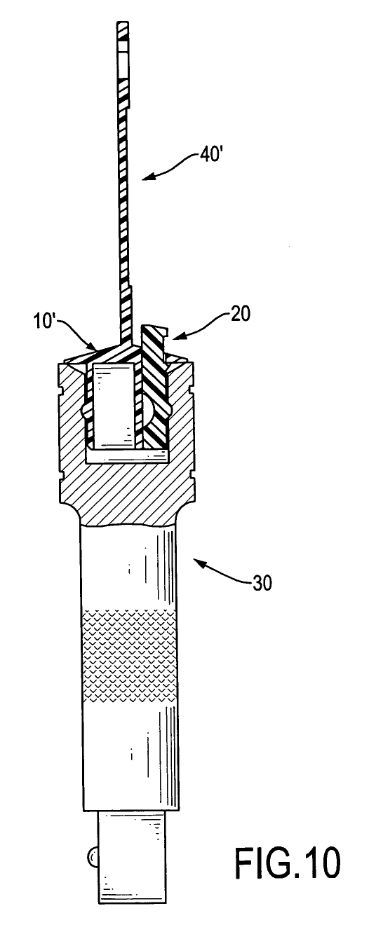

With reference to FIG. 10, it is noted that even when the description plate (40′) is integrally formed on top of the assembly column (10′), the operational procedure and the locking effect of the socket locking assembly to the socket remains the same as discussed earlier.

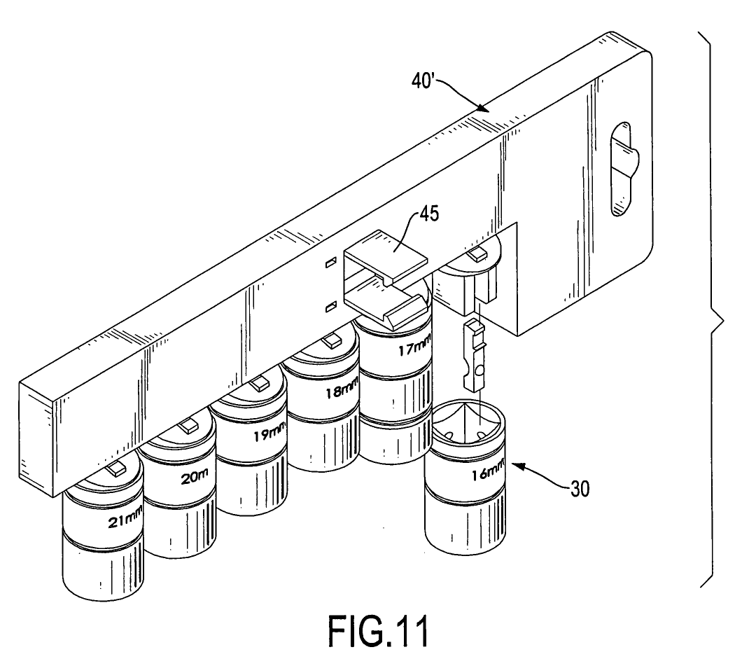

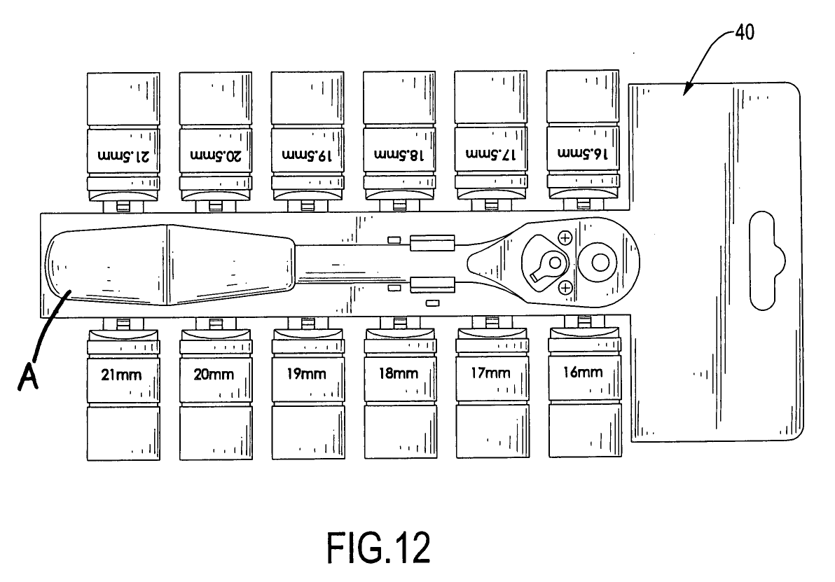

From the showing of FIG. 11 and FIG. 12, it is noted that multiple socket locking assemblies as well as multiple sockets (30) may be provided to only one side of the description plate (40′) and may provide to opposite sides of the description plate (40′) which has the first clamp (45) formed thereon to hold the wrench (A).

From the foregoing description, it is noted that the socket locking assembly of the present invention is able to adapt to sockets having therein a blind hole or a channel. That is, as long as the socket has a space (a blind hole or a channel) defined in one end thereof, the socket locking assembly of the present invention is applicable.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A socket locking assembly adapted for a socket having therein a space defined in one end of the socket and multiple indents defined in an inner face defining the space, the socket locking assembly comprising:
an assembly column having a body, two extensions extending from a bottom face of the body and extendable into the space of the socket, a positioning hole defined through the body and a retaining boss formed on a side face extending between the two extensions to be received in one of the indents of the socket; and
a locking pin having a top stop selectively extending through the positioning hole of the assembly column, a bottom stop formed on a side face of the locking pin to selectively abut a bottom face of the body of the assembly column and a secondary positioning boss formed on the side face of the locking pin to be received in one of the indents of the socket such that after the two extensions and the locking pin are extendable into the space of the socket and the top stop of the locking pin is extended through the positioning hole of the assembly column, abutment of the top stop with a top face of the body as well as the retaining boss and the secondary positioning boss received in the indents of the socket prevent the socket from removal.

2. The socket locking assembly as claimed in claim 1, wherein the bottom stop includes an inclined bottom face and a flat top face and is of a wedge shape such that the abutment of the flat top face of the bottom stop to the bottom face of the body prevents the secondary positioning boss to be received in the indent.

3. The socket locking assembly as claimed in claim 1, wherein the bottom stop includes an inclined bottom face, a flat top face and an arcuate cutout defined in a side face opposite to that of the secondary positioning boss and is of a wedge shape such that the abutment of the flat top face of the bottom stop to the bottom face of the body preliminarily prevents the secondary positioning boss to be received in the indent and only when the locking pin is deformed is the secondary positioning boss received in the indent of the socket.

4. The socket locking assembly as claimed in claim 1, wherein the locking pin is released from the assembly column only when the top stop is removed from the locking pin.

5. The socket locking assembly as claimed in claim 3, wherein the locking pin is released from the assembly column only when the top stop is removed from the locking pin.

6. The socket locking assembly as claimed in claim 5 further comprising a description plate having a dovetailed rail formed on a bottom face of the description plate and a dovetailed track formed on top of the assembly column to slidably receive therein the dovetailed rail of the description plate.

7. The socket locking assembly as claimed in claim 6 further comprising two holes defined in two opposed ends of the description plate and two locking bolts respectively extending into the two holes to prevent slidable movement of the dovetailed track of the assembly column relative to the dovetailed rail of the description plate.

8. The socket locking assembly as claimed in claim 6 further comprising a plug having a wing extending from a side of the plug and provided with multiple tubes formed on a side face of the wing, multiple rods formed on a side face of the description plate to correspond to and be received in the tubes to prevent slidable movement of the assembly column, a first clamp and a second clamp both formed on a side face opposite to the side face having thereon the rods to provide a firm grip for a wrench and an extension rod.

9. The socket locking assembly as claimed in claim 5 further comprising a description plate having two dovetailed rails formed on two opposed sides of the description plate and a dovetailed track formed on top of the assembly column to slidably receive therein the dovetailed rail of the description plate such that the assembly column is able to be slidably arranged on the two opposed sides of the description plate.

10. The socket locking assembly as claimed in claim 5 further comprising a description plate integrally formed on top of the assembly column.

11. The socket locking assembly as claimed in claim 10 further comprising a first clamp formed on a side face of the description plate for a wrench.
